(19) United States
(12) Patent Application Publication
(10) Pub. No.: US 2024/0096342 A1
(43) Pub. Date: Mar. 21, 2024

(54) PROCESSING APPARATUS AND PROCESSING METHOD OF SOUND SIGNAL

(71) Applicant: Wistron Corporation, New Taipei City (TW)

(72) Inventors: Han-Yi Liu, New Taipei City (TW); Chang-Hsin Lai, New Taipei City (TW)

(73) Assignee: Wistron Corporation, New Taipei City (TW)

(21) Appl. No.: 18/152,166

(22) Filed: Jan. 10, 2023

(30) Foreign Application Priority Data
Sep. 21, 2022 (TW) 111135798

(51) Int. Cl. G10L 21/0232; G06V 20/64; G10L 25/51

(52) U.S. Cl. CPC G10L 21/0232; G06V 20/64; G10L 25/51

(57) ABSTRACT

A processing apparatus and a processing method of a sound signal are provided. In the method, the sound signal is received. A respirator type is identified. The sound signal is modified according to the respirator type. The respirator type is a type of a respirator corresponding to the sound signal. Accordingly, the distortion may be corrected and the accuracy of voice identification may be improved.

### CROSS-REFERENCE TO RELATED APPLICATION

The application claims the priority benefit of Taiwan application serial no. 111135798, filed on Sep. 21, 2022. The entirety of the above-mentioned patent application is hereby incorporated by reference herein and made a part of the specification.

### BACKGROUND

### Technical Field

The disclosure relates to a signal processing, and more particularly, to a processing apparatus of a sound signal and a processing method of a sound signal.

### Description of Related Art

Respirators prevent the wearer from inhaling components such as smoke, aerosols, dusts or microorganisms. Therefore, some governments recommend that people wear respirators for infectious diseases transmitted by droplets.

It is worth noting that with the advancement of technology, many electronic products provide sound control functions. The sound control function needs to rely on voice identification technology. However, respirators block the transmission of sound waves, which affect the frequency response of the sound signal, thereby reducing the accuracy of the voice identification system.

### SUMMARY

Some embodiments of the disclosure provide a processing apparatus of a sound signal and a processing method of a sound signal, which can restore the sound signal, thereby improving the accuracy of voice identification.

The processing method of the sound signal according to an embodiment of the disclosure includes (but is not limited to) the followings: receiving the sound signal; identifying a respirator type; and modifying the sound signal according to the respirator type. The respirator type is a type of a respirator corresponding to the sound signal.

The processing apparatus of the sound signal according to an embodiment of the disclosure includes (but is not limited to) a memory and a processor. The memory is used to store a code. The processor is coupled to the memory. The processor is for loading the code. The processor receives the sound signal, identifies a respirator type, and modifies the sound signal according to the respirator type. The respirator type is a type of a respirator corresponding to the sound signal.

Based on the above, according to the processing apparatus and the processing method of the sound signal according to the embodiment of the disclosure, the sound signal is modified according to the identification result of the respirator. Accordingly, the interference of the respirator on the sound wave may be reduced, thereby improving voice identification.

In order to make the above-mentioned and other features and advantages of the disclosure easier to understand, the following embodiments are given and described in detail with the accompanying drawings as follows.

### BRIEF DESCRIPTION OF THE DRAWING

FIG. 1 is a component block diagram of a processing apparatus of a sound signal according to an embodiment of the disclosure.

FIG. 2 is a flow diagram of a processing method of a sound signal according to an embodiment of the disclosure.

FIG. 3A is a schematic diagram of a basic respirator.

FIG. 3B is a schematic diagram of a pattern respirator.

FIG. 3C is a schematic diagram of a fit respirator.

FIG. 4 is a flow diagram of modifying a signal according to an embodiment of the disclosure.

FIG. 5 is a flow diagram of a processing method of a sound signal for three respirator types according to an embodiment of the disclosure.

FIG. 6 is a flow diagram of generating a compensation signal according to an embodiment of the disclosure.

FIG. 7 is a frequency response diagram of an original signal and a training signal of three respirator types according to an embodiment of the disclosure.

FIG. 8 is a frequency response diagram of a compensation signal of three respirator types according to an embodiment of the disclosure.

FIG. 9 is a frequency response diagram of a compensation signal of a basic respirator according to an embodiment of the disclosure.

FIG. 10 is a frequency response diagram of a compensation signal of a pattern respirator according to an embodiment of the disclosure.

FIG. 11 is a frequency response diagram of a compensation signal of a fit respirator according to an embodiment of the disclosure.

FIG. 12 is a flow diagram of an identification method according to an embodiment of the disclosure.

### DESCRIPTION OF THE EMBODIMENTS

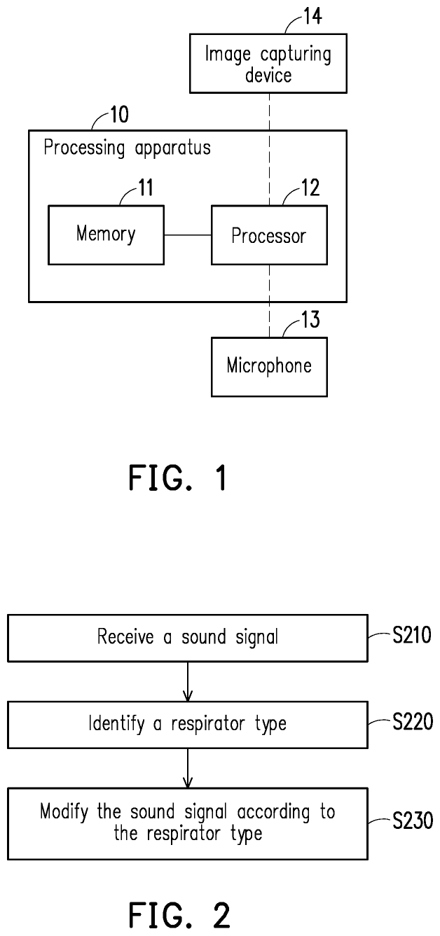

FIG. 1 is a component block diagram of a processing apparatus 10 of a sound signal according to an embodiment of the disclosure. Referring to FIG. 1, the processing apparatus 10 includes (but is not limited to) a memory 11 and a processor 12. The processing apparatus 10 may be a mobile phone, a tablet computer, a notebook computer, a desktop computer, an access control device, a voice assistant device, a smart home appliance, a wearable device, a vehicle-mounted device, or other electronic devices.

The memory 11 may be any type of a fixed or a removable random access memory (RAM), a read only memory (ROM), a flash memory, a hard disk drive (HDD), a solid state drive (SSD), or similar components. In an embodiment, the memory 11 is used to store a code, a software module, a configuration, data, or a file (e.g., a signal, a model, or a feature), which will be described in detail in subsequent embodiments.

The processor 12 is coupled to the memory 11. The processor 12 may be a central processing unit (CPU), a graphic processing unit (GPU), or other programmable general-purpose or special-purpose microprocessors, a digital signal processor (DSP), a programmable controller, a field programmable gate array (FPGA), an application-specific integrated circuit (ASIC), a neural network accelerator, or other similar components or a combination of the above components. In an embodiment, the processor 12 is used to execute all or part of the operations of the processing apparatus 10, and may load and execute various codes, software modules, files, and data stored in the memory 11. In some embodiments, part of the operations in the method of the embodiment of the disclosure may be implemented by different or the same processor 12.

In an embodiment, the processing apparatus 10 further includes a microphone 13. The processor 12 is coupled to the microphone 13. For example, the microphone 13 is connected to the processing apparatus 10 through USB, Thunderbolt, Wi-Fi, Bluetooth, or other wired or wireless communication technologies. As another example, the processing apparatus 10 has the built-in microphone 13. The microphone 13 may be a type of microphone such as a dynamic microphone, a condenser microphone, or an electret condenser microphone. The microphone 13 may also be a combination of other electronic components, analog-to-digital converters, filters, and audio processors that may receive the sound wave (e.g., a human sound, an ambient sound, a machine operation sound) and convert them into the sound signal. In an embodiment, the microphone 13 is used to pick up/record the sound of the speaker, so as to obtain the sound signal.

In an embodiment, the processing apparatus 10 further includes an image capturing device 14. The processor 12 is coupled to the image capturing device 14. For example, the image capturing device 14 is connected to the processing apparatus 10 through USB, Thunderbolt, Wi-Fi, Bluetooth, or other wired or wireless communication technologies. As another example, the processing apparatus 10 has the built-in image capturing device 14. The image capturing device 14 may be a camera, a video camera, or a monitor, and captures the image within a specified field of view accordingly. In an embodiment, the image capturing device 14 is used for taking a picture or a video of the speaker.

Hereinafter, the method according to the embodiment of the disclosure will be described in conjunction with the various apparatuses, components, and modules in the processing apparatus 10. Each process of the method may be adjusted accordingly according to the situation of implementation, and is not limited hereto.

FIG. 2 is a flow diagram of a processing method of a sound signal according to an embodiment of the disclosure. Referring to FIG. 2, the processor 12 receives the sound signal (step S210). Specifically, the processor 12 may receive the sound wave through the microphone 13 and generate the sound signal accordingly. The sound signal may be a human sound signal, a mechanical sound signal, a synthetic sound signal, an ambient sound signal, or a sound signal from other sound sources. That is, the sound source may be a person, a machine, a speaker, or any object in the environment. As another example, the processor 12 may receive the sound signal from an external recording equipment through a communication transceiver (not shown).

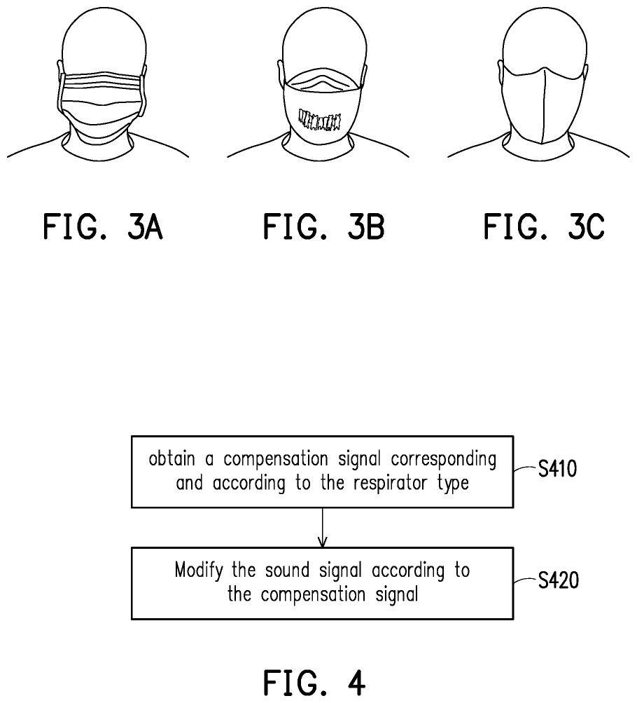

The processor 12 identifies the respirator type (step S220). Specifically, the respirator type is the respirator corresponding to the sound signal. For example, the speaker wears the respirator of the respirator type and speaks. As another example, the sound wave from other sound sources passes through the respirator of the respirator type. There are many types of respirators. For example, FIG. 3A is a schematic diagram of a basic respirator (e.g., a surgical respirator), FIG. 3B is a schematic diagram of a pattern respirator (e.g., a respirator with a woven or a printed pattern), and FIG. 3C is a schematic diagram of a fit respirator. These are the common respirator types on the market. In addition, the respirator type may also be an N95 or a face respirator type, and is not limited by the embodiment of the disclosure.

In an embodiment, the processor 12 takes a picture of the speaker or other sound sources through the image capturing device 14 to obtain the image of the speaker or the sound source, or obtains the image captured from an external video apparatus. Next, the processor 12 may identify the respirator type of the respirator in the image.

For example, the processor 12 may pre-process the image through an OpenCV algorithm (e.g., adjust contrast, adjust brightness, or crop the image), and identify the respirator type through a classifier. The classifier is trained based on a machine learning algorithm (e.g., a supervised or a semi-supervised learning). The classifier may be used for object identification/detection. There are many algorithms for object identification, for example, a YOLO (You Only Look Once), a SSD (Single Shot Detector), or a R-CNN. Alternatively, the processor 12 may realize object identification through a feature-based matching algorithm (e.g., a histogram of oriented gradient (HOG), a Harr, or a speeded up robust features (SURF)).

It should be noted that the embodiment of the disclosure does not limit the algorithm used for object identification/detection. In an embodiment, the aforementioned object detection may also be performed by an external apparatus which provides the identification result to the processing apparatus 10.

In another embodiment, the processor 12 may identify the respirator type according to the sound feature of the sound signal. For example, the respirator blocks high frequency bands (2 to 10 (kHz)) more apparently. Different respirator types, for example, have large differences in attenuation between 2 and 5 kHz. Therefore, the processor 12 may distinguish different respirator types based on the attenuation amplitude of the sound signal at a specific frequency or frequency band in the frequency domain.

It should be noted that there are many kinds of sound features, and may be values obtained by a specific algorithm. As long as the different respirator types have a different value for a specific sound feature, they may be used to identify respirator types.

Referring to FIG. 2, the processor 12 modifies the sound signal according to the respirator type (step S230). Specifically, as described above, the respirator affects the sound signal, thereby causing distortion. For example, the amplitude of sound signal is attenuated at a high frequency. Therefore, it is necessary to correct the distortion of the sound signal.

FIG. 4 is a flow diagram of modifying a signal according to an embodiment of the disclosure Referring to FIG. 4, the processor 12 may obtain a compensation signal corresponding and according to the respirator type (step S410). Different respirator types have different effects on the sound signal. The compensation signal may be used to restore or approximate the sound signal to the original signal obtained without the respirator. Next, the processor 12 may modify the sound signal according to the compensation signal obtained (step S420). For example, the processor 12 may superimpose the compensation signal and the sound signal in the frequency domain. As another example, the processor 12 may convert the compensation signal and the sound signal into the modified sound signal through an equation.

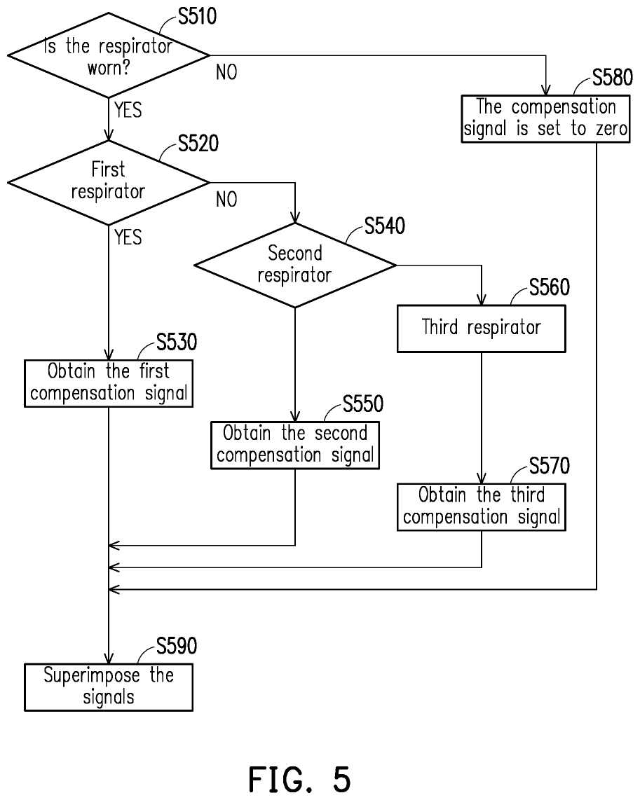

FIG. 5 is a flow diagram of a processing method of a sound signal for three respirator types according to an embodiment of the disclosure. Referring to FIG. 5, the processor 12 may determine whether the speaker or the sound source is wearing the respirator or is covered by the respirator (step S510). If the speaker or the sound source is wearing the respirator or is covered by the respirator, the processor 12 determines whether the respirator type worn is the first respirator (e.g., the basic respirator shown in FIG. 3A) (step S520). If the respirator type is the first respirator, the processor 12 obtains the first compensation signal corresponding to the first respirator (step S530). If the respirator type is not the first respirator, the processor 12 continues to determine whether the respirator type is the second respirator (e.g., the pattern respirator shown in FIG. 3B) (step S540). If the respirator type is the second respirator, the processor 12 obtains the second compensation signal corresponding to the second respirator (step S550). If the respirator type is not the second respirator, the processor 12 continues to determine whether the respirator type is the third respirator (e.g., the fit respirator shown in FIG. 3C) (step S560). If the respirator type is the third respirator, the processor 12 obtains the third compensation signal corresponding to the third respirator (step S570). If the respirator type is not the third respirator, the processor 12 determines that the speaker is not wearing the respirator or is not covered by the respirator (i.e., an absence of the respirator) and sets the compensation signal to zero (step S580). Next, the processor 12 superimposes the compensation signal obtained and the sound signal (step S590).

It should be noted that the embodiment of the disclosure is not limited to the three respirator types, and the processor 12 may directly determine without sequentially comparing the respirator types. That is, the processor 12 may simultaneously perform steps S520, S540, S560 to directly determine if the speaker or the sound source corresponds to the first respirator, the second respirator, the third respirator, or other respirator types, and obtain the corresponding compensation signal.

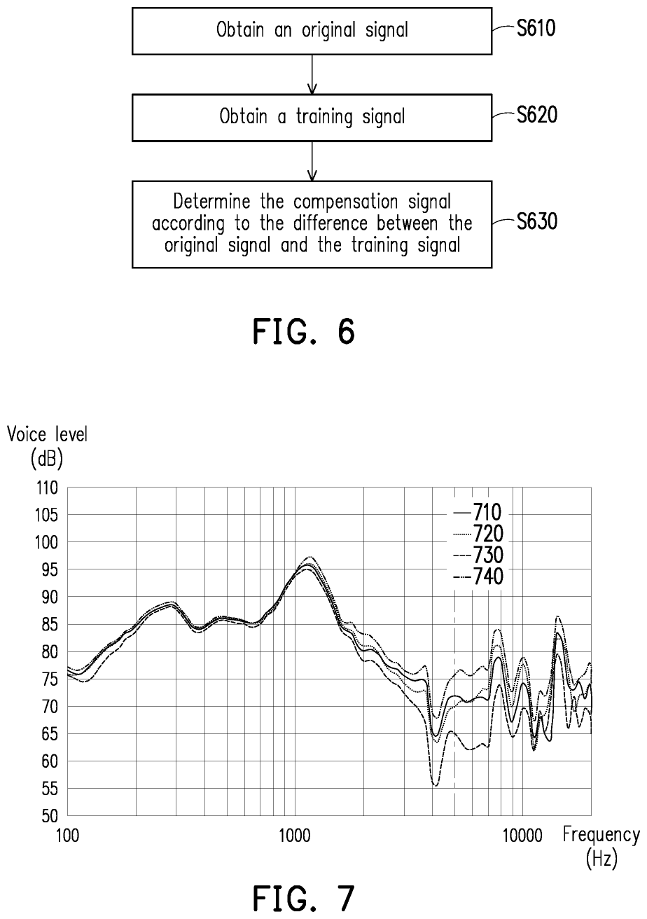

FIG. 6 is a flow diagram of generating a compensation signal according to an embodiment of the disclosure. Referring to FIG. 6, the processor 12 may obtain the original signal (step S610). The original signal is the sound signal generated without the respirator, for example, when the speaker is not wearing the respirator or when the sound source is not covered by the respirator. For example, the original signal may be recorded through the microphone 13 or other recording equipment obtained. The original signal is the target of modification. The processor 12 may obtain the training signal (step S620). The training signal is the sound signal generated by a certain respirator type. For example, the speaker wears a certain respirator type or the sound source is covered by such a respirator type and generates the sound. For example, the speaker wears the basic respirator, and records the training signal through the microphone 13 or other recording equipment obtained. The processor 12 may generate the compensation signal according to the difference between the original signal and the training signal (step S630). For example, the compensation signal Cₓ(f) is determined according to the following equation:

C_{X}(f)=H(f)−M_{X}(f)

where x is the number of the respirator type and may be a positive integer. For example, x=1 is the basic type, x=2 is the pattern type, and x=3 is the fit type. H(f) is the original signal, and Mₓ(f) is the training signal for the type x respirator. The compensation signal may be stored in the memory 11 and used for subsequent modification of the sound signal.

As an example, FIG. 7 is a frequency response diagram of an original signal and a training signal of three respirator types according to an embodiment of the disclosure. Referring to FIG. 7, an original signal 710 corresponds to the situation of not wearing a respirator. A training signal 720 corresponds to the situation where the speaker wears the basic respirator of FIG. 3A. A training signal 730 corresponds to the situation where the speaker wears the basic respirator of FIG. 3B. A training signal 740 corresponds to the situation where the speaker wears the basic respirator of FIG. 3C.

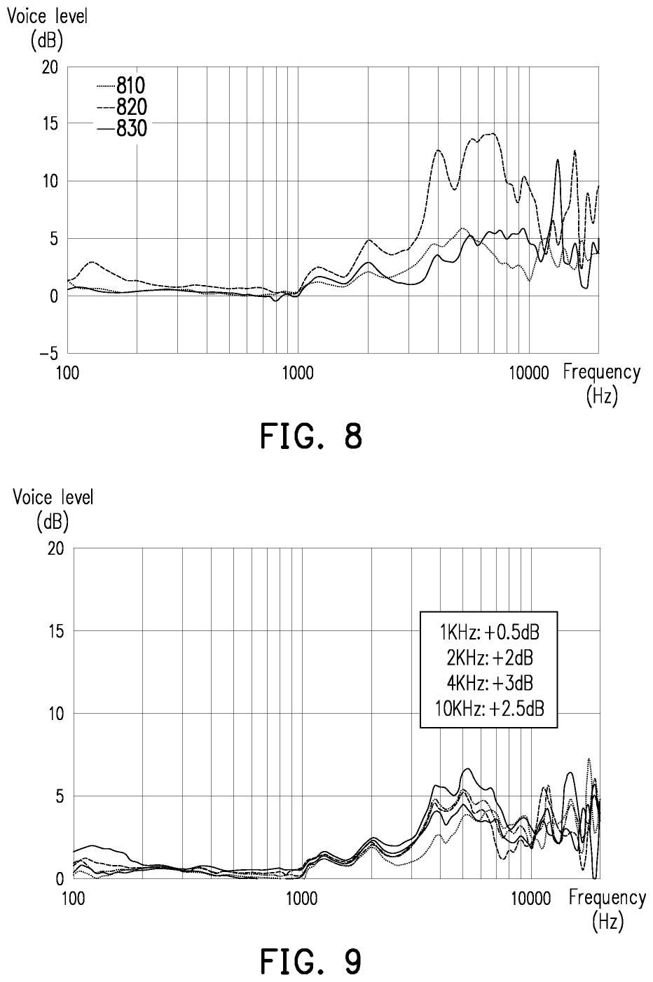

FIG. 8 is a frequency response diagram of a compensation signal of three respirator types according to an embodiment of the disclosure. Referring to FIG. 8, a compensation signal 810 is used to modify the sound signal obtained when the speaker wears the basic respirator of FIG. 3A or when other sound sources are covered by the basic respirator of FIG. 3A. A compensation signal 820 is used to modify the sound signal obtained when the speaker wears the pattern respirator of FIG. 3B or when other sound sources are covered by the pattern respirator of FIG. 3B. A compensation signal 830 is used to modify the sound signal obtained when the speaker wears the fit respirator of FIG. 3C or when other sound sources are covered by the fit respirator of FIG. 3C. The sound signal may be restored to the original signal 710 shown in FIG. 7 after being modified according to the corresponding compensation signal 810, compensation signal 820, and compensation signal 830.

The compensation value of the compensation signal of different respirator types may be different at different frequencies. For example, FIG. 9 is a frequency response diagram of a compensation signal of a basic respirator according to an embodiment of the disclosure. Referring to FIG. 9, the compensation value of five basic respirators at 1 kHz, 2 kHz, 4 kHz, and 10 kHz are about +0.5 dB, +2 dB, +3 dB, and +2.5 dB, respectively.

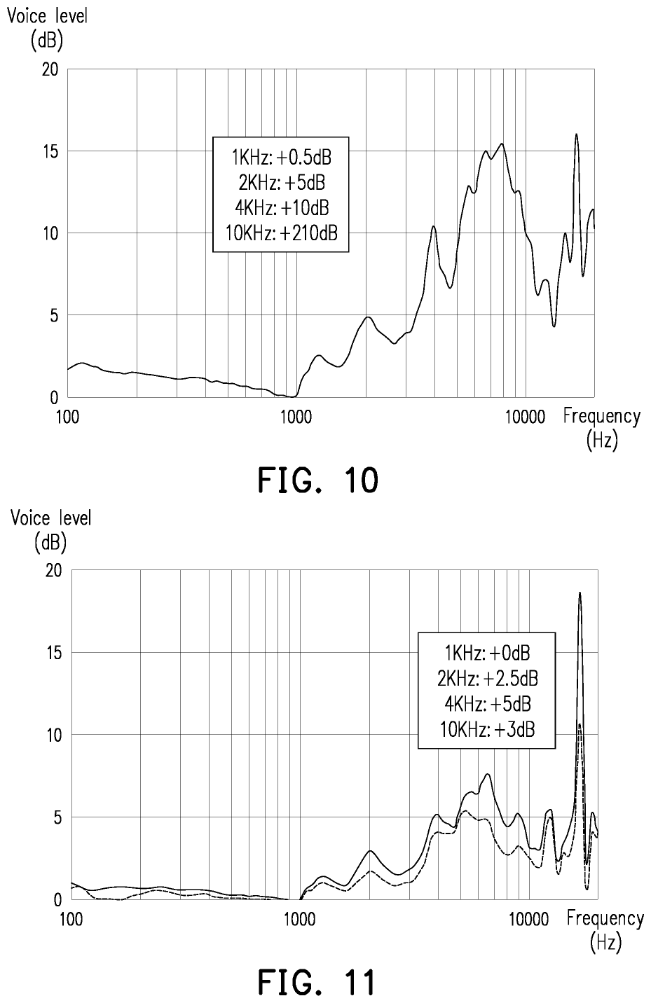

FIG. 10 is a frequency response diagram of a compensation signal of a pattern respirator according to an embodiment of the disclosure. Referring to FIG. 10, the compensation value of the pattern respirator at 1 kHz, 2 kHz, 4 kHz, and 10 kHz are about 0 dB, +5 dB, +10 dB, and +10 dB, respectively.

FIG. 11 is a frequency response diagram of a compensation signal of a fit respirator according to an embodiment of the disclosure. Referring to FIG. 11, the compensation value of the two fit respirators at 1 kHz, 2 kHz, 4 kHz, and 10 kHz are about 0 dB, +2.5 dB, +5 dB, and +3 dB, respectively.

The modified sound signal may be used for voice identification. In an embodiment, the processor 12 may identify in response to the sound signal is a registered signal according to the modified sound signal. The registered signal is the signal that is allowed to pass the verification, for example, the sound signal of a registrant who passed the identify verification.

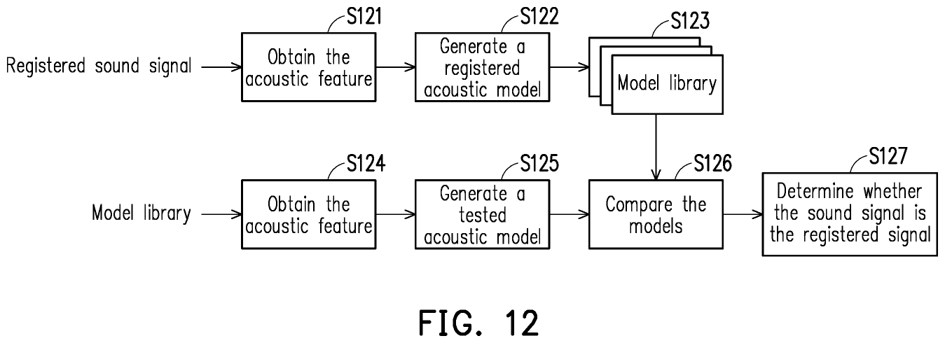

There are many methods of voice identification. FIG. 12 is a flow diagram of an identification method according to an embodiment of the disclosure. Referring to FIG. 12, the processor 12 may obtain the acoustic feature of the registered sound signal (step S121). The registered sound signal is the sound signal generated by the registrant or other sound sources. For example, the processor 12 may use a Mel-Frequency Cepstral Coefficient (MFCC), a fBank, a log FBank, or other algorithms to obtain the acoustic feature. The processor 12 may generate a registered acoustic model of the registered signal according to a first acoustic feature of the registered sound signal (step S122). For example, the processor 12 may generate the acoustic model using a Hidden Markov Model (HMM). Next, the processor 12 stores the registered acoustic model of the registered signal in a model library (S123).

On the other hand, the processor 12 may obtain the acoustic feature of the modified sound signal (step S124). Similarly, the processor 12 may derive acoustic signatures using an MFCC, a fBank, a log FBank, or other algorithms. Next, the processor 12 may generate a tested acoustic model of the speaker or other sound sources according to a second acoustic feature of the modified sound signal (step S125).

The processor 12 may compare the tested acoustic model with the registered acoustic model in the model library (step S126) and determine whether the sound signal is the registered signal according to the comparison result between the registered acoustic model and the tested acoustic model (step S127). In response to the sound signal is the registered signal according to a comparison result showing the registered acoustic model is the same as the tested acoustic model. For example, if the registered acoustic model is the same as the tested acoustic model, the sound signal is the registered signal. For example, the current speaker is the registrant. If the registered acoustic model is different from the tested acoustic model, the sound signal is not the registered signal. For example, the current speaker is not the registrant. Alternatively, the processor 12 may directly identify whether the sound signal is the registered signal by using an identification model based on the machine learning algorithm.

In other embodiments, the modified sound signal may also be used by other voice identification applications, for example, voice-to-text, voice dialing, voice command, or voice navigation.

To sum up, in the processing apparatus and the processing method of the sound signal of the embodiment of the disclosure, the corresponding compensation signal is provided for the respirator type identified so as to modify the sound signal. Accordingly, the distortion caused by the respirator may be corrected, thereby improving the accuracy of voice identification.

Although the disclosure has been described with reference to the embodiments above, the embodiments are not intended to limit the disclosure. Any person skilled in the art may make some changes and modifications without departing from the spirit and scope of the disclosure. Therefore, the scope of the disclosure will be defined in the appended patent application.

What is claimed is:

1. A processing method of a sound signal, comprising:
receiving the sound signal;
identifying a respirator type, wherein the respirator type is a type of a respirator corresponding to the sound signal; and
modifying the sound signal according to the respirator type.

2. The processing method according to claim 1, wherein modifying the sound signal according to the respirator type comprises:
obtaining a compensation signal corresponding and according to the respirator type; and
modifying the sound signal according to the compensation signal.

3. The processing method according to claim 2, wherein modifying the sound signal according to the compensation signal comprises:
superimposing the compensation signal and the sound signal in a frequency domain.

4. The processing method according to claim 2, wherein modifying the sound signal according to the compensation signal comprises:
setting the compensation signal to zero in response to an absence of the respirator.

5. The processing method according to claim 2, further comprising:
obtaining an original signal, wherein the original signal is the sound signal generated without the respirator;
obtaining a training signal, wherein the training signal is the sound signal generated through the respirator of the respirator type; and
getting the compensation signal according to a difference between the original signal and the training signal.

6. The processing method according to claim 1, wherein identifying the respirator type comprises:
identifying the respirator type of the respirator in an image.

7. The processing method according to claim 6, wherein identifying the respirator type comprises:
identifying the respirator type through a classifier, wherein the classifier is trained based on a machine learning algorithm.

8. The processing method according to claim 1, wherein identifying the respirator type comprises:
identifying the respirator type according to a sound feature of the sound signal.

9. The processing method according to claim 1, further comprising:
identifying in response to the sound signal is a registered signal according to a modified sound signal.

10. The processing method according to claim 9, wherein identifying in response to the sound signal is the registered signal according to the modified sound signal comprises:
generating a registered acoustic model of the registered signal according to a first acoustic feature of a registered sound signal;
generating a tested acoustic model of the sound signal according to a second acoustic feature of the modified sound signal; and
determining whether the sound signal is the registered signal according to a comparison result between the registered acoustic model and the tested acoustic model, wherein in response to the sound signal is the registered signal according to a comparison result showing the registered acoustic model is the same as the tested acoustic model.

11. A processing apparatus of a sound signal, comprising:
a memory for storing a code; and
a processor, coupled to the memory, and for loading the code, wherein the processor:
receives the sound signal;
identifies a respirator type, wherein the respirator type is a type of a respirator corresponding to the sound signal; and
modifies the sound signal according to the respirator type.

12. The processing apparatus according to claim 11, wherein the processor further:
obtains a compensation signal corresponding and according to the respirator type; and
modifies the sound signal according to the compensation signal.

13. The processing apparatus according to claim 12, wherein the processor further:
superimposes the compensation signal and the sound signal in a frequency domain.

14. The processing apparatus according to claim 12, wherein the processor further:
sets the compensation signal to zero in response to an absence of the respirator.

15. The processing apparatus according to claim 12, wherein the processor further:
obtains an original signal, wherein the original signal is the sound signal generated without the respirator;
obtains a training signal, wherein the training signal is the sound signal generated through the respirator of the respirator type; and
generates the compensation signal according to a difference between the original signal and the training signal.

16. The processing apparatus according to claim 11, wherein the processor further:
identifies the respirator type of the respirator in an image.

17. The processing apparatus according to claim 16, wherein the processor further:
identifies the respirator type through a classifier, wherein the classifier is trained based on a machine learning algorithm.

18. The processing apparatus according to claim 11, wherein the processor further:
identifies the respirator type according to a sound feature of the sound signal.

19. The processing apparatus according to claim 11, wherein the processor further:
identifies in response to the sound signal is a registered signal according to a modified sound signal.

20. The processing apparatus according to claim 19, wherein the processor further:
generates a registered acoustic model of the registered signal according to a first acoustic feature of a registered sound signal;
generates a tested acoustic model of the sound signal according to a second acoustic feature of the modified sound signal; and
determines whether the sound signal is the registered signal according to a comparison result between the registered acoustic model and the tested acoustic model, wherein in response to the sound signal is the registered signal according to a comparison result showing the registered acoustic model is the same as the tested acoustic model.
